(19) United States
(12) Patent Application Publication
(10) Pub. No.: US 2002/0141606 A1
(43) Pub. Date: Oct. 3, 2002

(54) Power supply assembly

(76) Inventors: Richard Schweder, Powell, OH (US); Claus Zimmermann, Newbury Park, CA (US)

Correspondence Address: Albert O. Cota, 5460 White Oak Ave., A-331, Encino, CA, 91316, US

(21) Appl. No.: 09/779,573

(22) Filed: Feb. 9, 2001

(51) Int. Cl. H04R 3/00

(52) U.S. Cl. 381/116; 381/111

(57) ABSTRACT

A power supply assembly (10) specifically designed to supply a bias voltage to a diaphragm (34) located on an electrolytic or electrostatic speaker(s)(32). The assembly (10) produces the bias voltage from an audio signal derived from an audio amplifier (30). Thus, a direct connection to a utility power source is not required. The assembly (10) is comprised of five major circuits: a rectifier and filter circuit (12) which converts the input audio signal to a regulated d-c current, an adjustable regulator circuit (14) which is applied the regulated d-c current and produces a regulated direct-current voltage, a d-c to a-c inverter circuit (16) which receives the regulated d-c voltage and produces a high voltage a-c, an eight-times multiplier and rectifier circuit (18) which receives the high-voltage a-c and produces a regulated high voltage d-c, and a current limiter circuit (20) which receives the regulated high voltage d-c and produces the bias voltage which biases the diaphragm (34).

### TECHNICAL FIELD

The invention pertains to the general field of power supplies, and more particularly to a power suppler that supplies a high, d-c bias voltage to a diaphragm in an electrolytic or an electrostatic loudspeaker.

### BACKGROUND ART

Most conventional electrostatic speakers consist of a flexible center membrane or diaphragm having on each side a fixed electrode typically consisting of a grid of wires. The electrodes are placed apart, thereby enabling sound waves, which are generated by the movement of the flexible diaphragm, to be emitted. The electrodes are held within a dielectric material and the flexible diaphragm is coated with a highly-resistive material. The diaphragm is typically suspended within an open-latticed frame, between the electrodes so that when operated, relatively small segments of the diaphragm vibrate as a result of an applied bias voltage and the resulting electrostatic fields acting upon the diaphragm.

Electrostatic loudspeakers are considered to be superior in many respects over the moving-coil type of speaker. However, they have received generally poor acceptance as a result of complexity of their design, low acoustic output, the requirement for a comparatively large radiating area, and a dependence upon the application of relatively high, d-c bias voltage that is applied to the diaphragm. For example, a typical full-range push-pull electrostatic speaker requires a bias voltage of 3500 volts d-c and an audio amplifier having a power output from 60 to 100 watts.

The current bias power supplies are typically connected to a utility power source. The instant inventive power supply does not require a utility power source—its input is derived directly from the output of the audio amplifier.

A search of the prior art did not disclose any patents that read directly on the claims of the instant invention however, the following U.S. patents were considered related:

| PAT. NO. | INVENTOR | ISSUED |
|---|---|---|
| 5,392,358 | Driver | Feb. 21, 1995 |
| 4,160,882 | Driver | Jul. 10, 1979 |
| 3,942,029 | Kawakami et al | mar. 2, 1976 |

PCT/U.S. Pat. No. 98/11275 Published WO 98/57523 17 Dec. 17, 1998

The U.S. Pat. No. 5,392,358 Driver patent discloses an electrolytic loudspeaker assembly that is designed to reproduce a broad band of audio signals. The loudspeaker assembly consists of a thin, non-magnetic capacitive transducer and a transducer driver unit. The transducer consists of a compound diaphragm further consisting of a vibratory center section having attached to each of its surfaces a respective front section and a back section. All three sections of the compound diaphragm are held captive by a frame assembly. The transducer is driven and controlled by the transducer driver unit which couples the audio signal to the transducer's front and back sections and supplies an unregulated, d-c bias voltage to the transducer's center section.

The U.S. Pat. No. 4,160,882 Driver patent discloses an electrostatic transducer loudspeaker. The transducer consists of two parallel diaphragms each consisting of two plastic sheets, having different charge-carrying characteristics, that are sandwiched between an electrically-conductive layer. The two diaphragms are separated by a centrally-located, perforated electrically-conductive sheet and a dielectric material sandwiched between the conductive sheet and each diaphragm. The diaphragms two electrically-conductive layers are connected across the secondary winding of an audio transformer and the centered, electrically-conductive sheet is connected to the center tap of the transformer. When the transformer is applied an audio signal the two diaphragms are driven in a push-pull relation to reproduce the applied audio.

The U.S. Pat. No. 3,942,029 Kawakami, et al patent discloses an electrostatic transducer that can be utilized as either a speaker or microphone. The transducer consists of a vibrating plate or electret diaphragm having a monocharge of positive or negative potential on its surface. The electret diaphragm is made of a thin polymer film that is bonded to a support so that uniform tension exits. A pair of electrically conductive electrodes are brought in contact with opposite sides of the polymer films, and an electrostatic shield, such as a mesh, covers the surface of the two electrodes. A d-c voltage is time-applied across the electrodes to allow the electret to heat to its cured temperature of 120° C. The electret is subsequently cooled to produce a quasi-permanent state of electric polarization.

The published PCT document WO 98/57522 consists of a compilation of improvements and modifications to U.S. Pat. No. 5,392,358. The improvements affect the compound diaphragm of the capacitive transducer and the transducer driver unit.

### DISCLOSURE OF THE INVENTION

The power supply assembly produces a regulated and stable d-c bias voltage which applied to a diaphragm of an electrolytic or electrostatic speaker. The assembly does not required direct connection to a utility power source the input to the assembly is a portion of the audio signal derived from the output of an audio amplifier that drives the speakers. In its most basic design, the power supply assembly is comprised of a:

a) means for converting the input audio signal from the audio amplifier to a direct current,

b) means for receiving the direct current and producing a regulated direct-current voltage,

c) means for converting the regulated direct-current voltage to a high voltage alternating-current,

d) means for converting the high voltage alternating-current to a regulated high voltage direct-current, and

e) means for limiting the regulated direct-current high voltage prior to being applied as the output bias voltage to the diaphragm.

The means for converting the input audio signal to the direct current consists of a full-wave rectifier and subsequent capacitor filtering. The direct current is then converted to a regulated direct-current voltage by an adjustable regulator circuit which preferably consists of a National Semiconductor integrated circuit LM117T. From the regulator circuit the direct-current voltage is converted to a high voltage alternating-current which is applied to an eight-times multiplier and rectifier circuit from where a high voltage direct-current is produced. The output from the eight-times multiplier and rectifier circuit is then limited by a current limiter circuit from where the regulated direct-current bias voltage is applied to the diaphragm of the electrolytic or electrostatic speaker.

In view of the above disclosure, it is the primary object of the invention to produce a power supply assembly that:

1) provides a highly stable and regulated bias voltage, and

2) operates from an input signal derived directly from the audio output of an audio amplifier. Thus, no direct input to a utility power source is required.

In addition to the above object of the invention it is also an object of the invention to produce a power supply assembly that:

can be designed as a separate unit or be integrated into the enclosure of an audio amplifier,

is reliable, and

is cost effective from both a manufacturer's and consumer's point of view.

These and other objects and advantages of the present invention will become apparent from the subsequent detailed description of the preferred embodiment and the appended claims taken in conjunction with the accompanying drawings.

### BRIEF DESCRIPTION OF THE DRAWINGS

FIG. 1 is a block diagram of the power supply assembly shown receiving an input from an audio amplifier and producing a bias voltage that is applied to a diaphragm of an electrolytic or electrostatic speaker.

FIGS. 2A-2C are schematic diagrams of the power supply assembly partitioned to correspond with the block diagram.

### BEST MODE FOR CARRYING OUT THE INVENTION

The best mode for carrying out the invention is presented in terms of a preferred embodiment for a power supply assembly 10 that is specifically designed to produce a bias voltage. The bias voltage functions to charge a diaphragm located on an electrolytic or an electrostatic speaker that is driven by an audio amplifier.

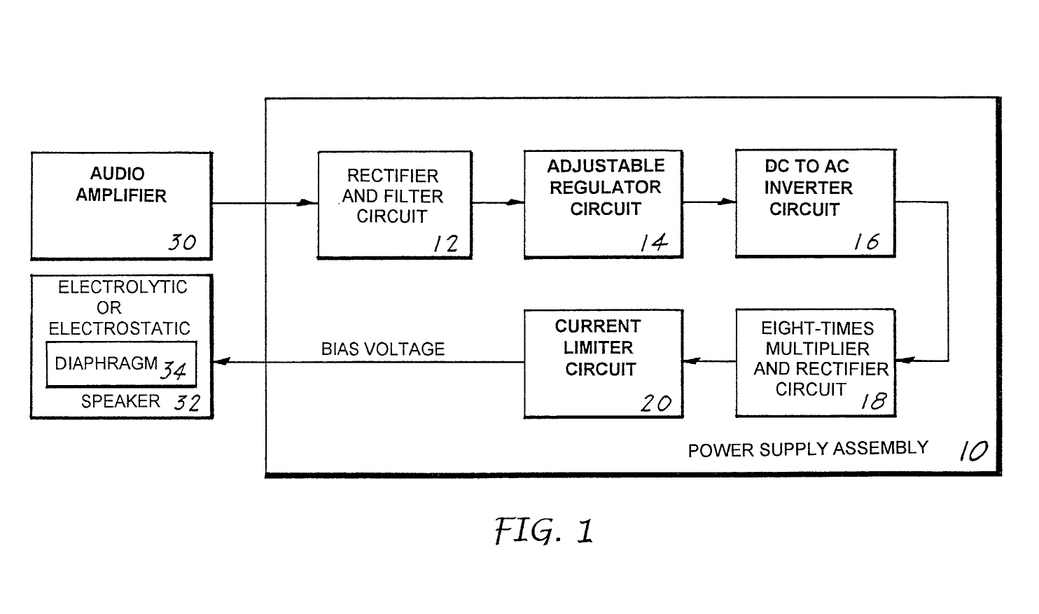

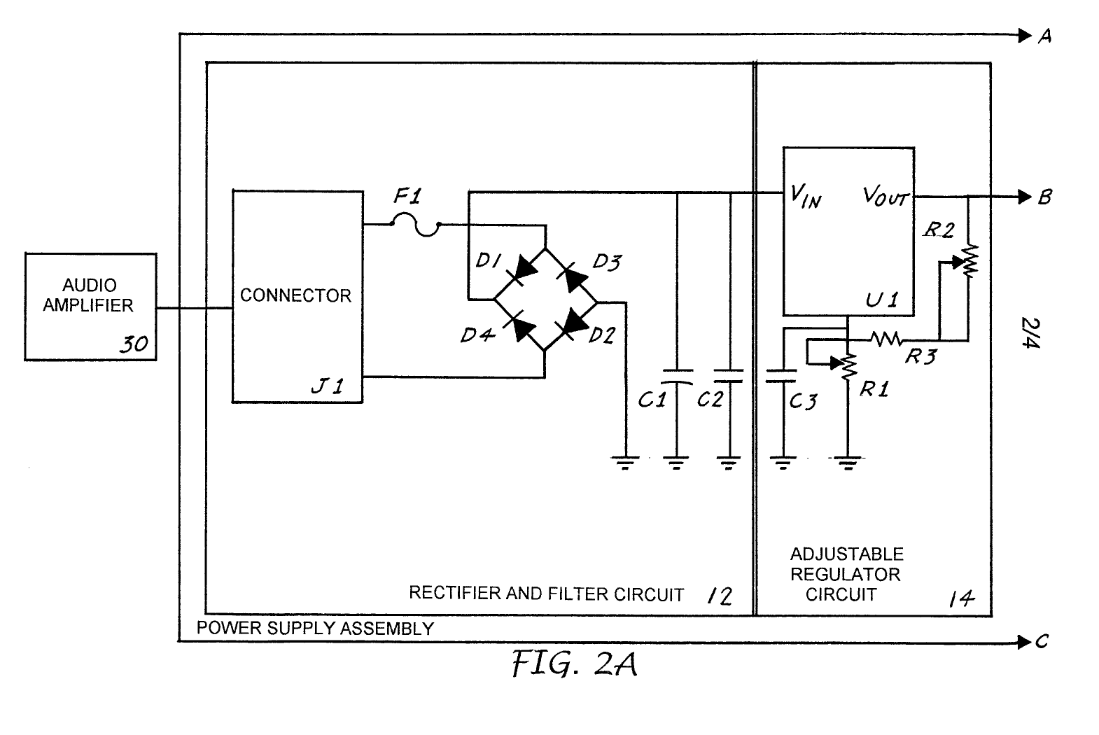

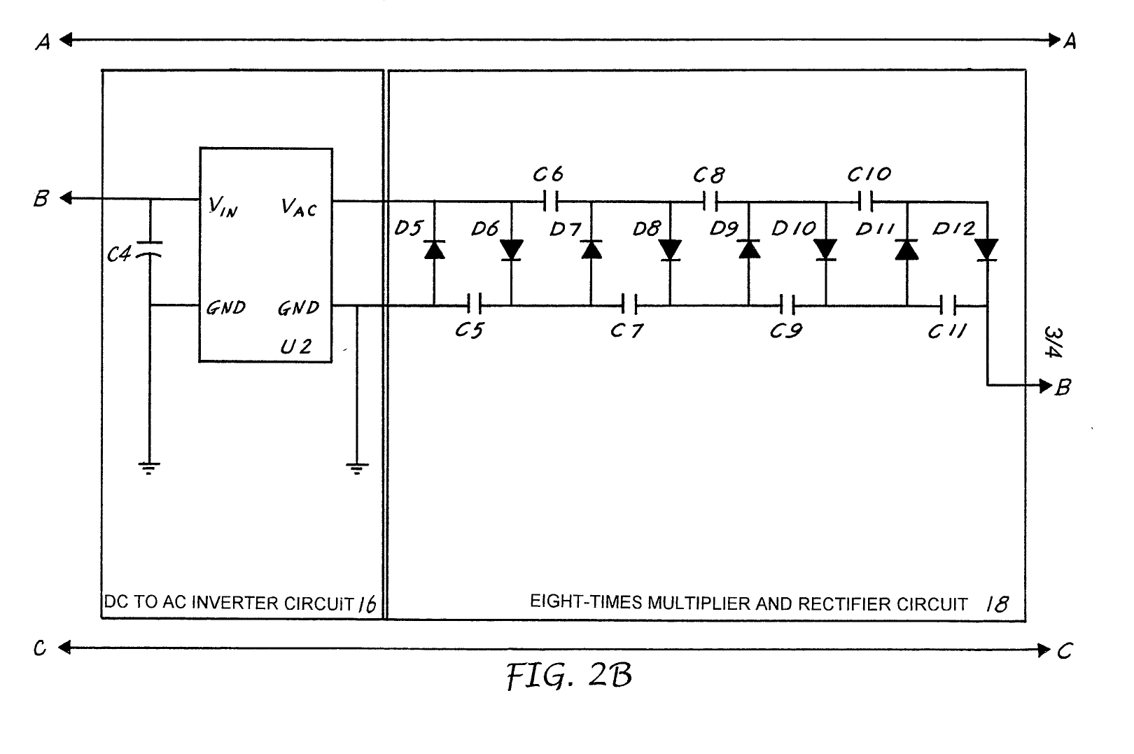

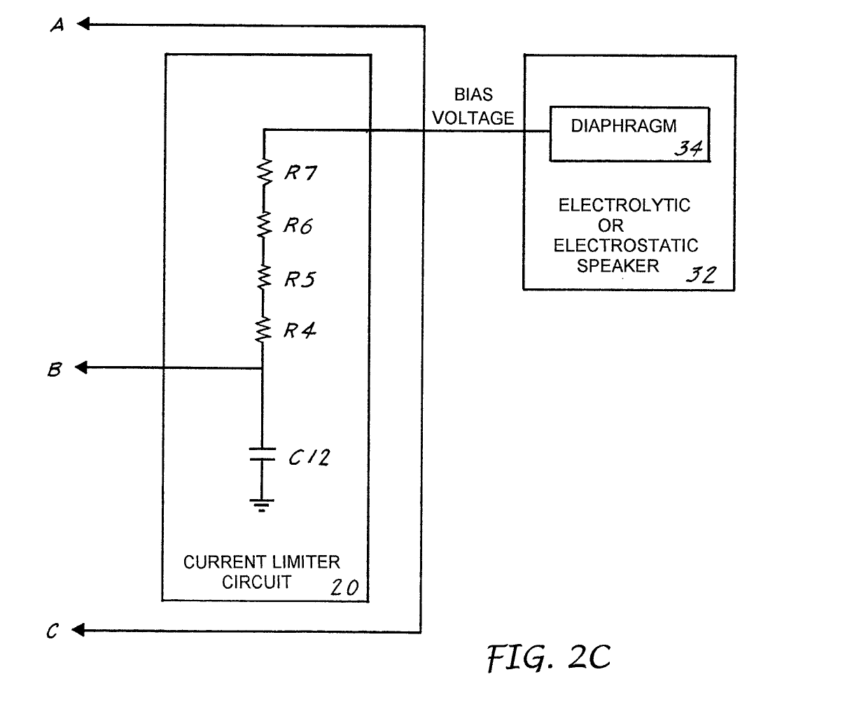

The preferred embodiment of the power supply assembly 10, as shown in the block diagram of FIG. 1 and the schematic diagram of FIGS. 2A, 2B, and 2C, is comprised of the following major circuits: a rectifier and filter circuit 12, an adjustable regulator circuit 14, a dc to ac inverter circuit 16, an eight-times multiplier and rectifier circuit 18 and a current limiter circuit 20. The assembly 10 operates in combination with at least one audio amplifier 30 and at least one electrolytic or electrostatic speaker 32, (hereinafter “speaker 32”), which includes a diaphragm 34 to which is applied the bias voltage.

The input circuit of the power supply assembly 10 is the rectifier and filter circuit 12, which is shown in FIG. 2A. The circuit 12 includes a means for receiving an audio signal from the audio amplifier 30 via a connector J1 and a fuse F1. The audio signal is initially filtered by a full-wave rectifier, consisting of diodes D1-D4 and filtered by a pair of electrolytic capacitors C1 and C2 from where the output from the circuit 12 is a direct current.

The adjustable regulator circuit 14, as also shown in FIG. 2A, includes a means for receiving the direct current from the circuit 12 and producing a regulated direct-current voltage that is set to an optimum level. The direct current from the circuit 12 is applied to an integrated circuit U1 which preferably is comprised of a National Semiconductor LM117T. The circuit U1 is connected to a pair of potentiometers R1 and R2. Potentiometer R1 is externally adjustable to set the bias voltage at a preselected level which is typically set at 4000 volts d-c. Potentiometer R2 is a trimmer adjustment that is factory set to limit the bias voltage to a maximum level of between 3000 and 5000 volts; d-c connected to the ungrounded section of potentiometer R1 is a noise suppression capacitor C3.

The dc to ac inverter circuit 16, as shown in FIG. 2B, includes means for receiving and connecting the regulated direct-current voltage, from the circuit 14, to a high voltage alternating-current. The circuit 16 operates with an integrated circuit U2 and a noise suppression capacitor C4 which functions in combination to produce the high voltage alternating-current which typically set at 400 volts a-c. The integrated circuit U2 is preferably comprised of a JKL, Components Inc. BXA-501.

The eight-times multiplier and rectifier circuit 18, as also shown in FIG. 2B, include means for receiving and converting the high voltage alternating current to a regulated high voltage direct-current. The circuit 18 is comprised of a series network of eight diode D5-D12 and seven capacitors C5-C11 which function in combination to produce the regulated high voltage direct-current.

The final circuit comprising the power supply assembly 10 is the current limiter circuit 20 which is shown in FIG. 2C. The circuit 20 includes means for receiving and limiting the regulated high voltage direct-current from the circuit 18. The circuit 20 is comprised of a resistor ladder network consisting of current limiting resistors R4-R7 and a reservoir capacitor C12 which is connected to resistor E4 to ground. The developed bias voltage which is produced from resistor R7, is applied to the diaphragm 34 as shown in FIG. 20. The bias voltage produced by the circuit 10 is maintained at better than one percent regulation which aids in improving the sound quality of the speakers 32.

While the invention has been described in complete detail and pictorially shown in the accompanying drawings it is not to be limited to such details, since many changes and modifications may be made to the invention without departing from the spirit and the scope thereof. For example, although the circuit 10 is described in terms of primarily discreet components, the circuit 10 can also be designed with an application specific integrated circuit (ASIC). The ASIC would allow the circuit 10 to be packaged in a smaller package and have a higher reliability. Hence, it is described to cover any and all modifications and forms which may come within the language and scope of the claims.

1. A power supply assembly designed to produce a bias voltage that charges a diaphragm located on an electrolytic or electrostatic speaker driven by an audio amplifier, said assembly comprising:
a) means for converting an input audio signal from the audio amplifier to a direct current,
b) means for receiving the direct current and producing a regulated direct-current voltage,
c) means for converting the regulated direct-current voltage to a high voltage alternating-current,
d) means for converting the high voltage alternating-current to a regulated high voltage direct-current, and
e) means for limiting the regulated direct-current high voltage prior to being applied as the output bias voltage to the diaphragm.

2. The assembly as specified in claim 1 wherein said means for converting the audio signal to the direct current comprise a rectifier and filter circuit.

3. The assembly as specified in claim 2 wherein said rectifier comprises a full wave rectifier.

4. The assembly as specified in claim 1 wherein said means for producing the regulated direct current voltage comprises an adjustable regulator.

5. The assembly as specified in claim 4 wherein said adjustable regulator comprises a National Semiconductor Integrated circuit LM117T.

6. The assembly as specified in claim 1 wherein said means for converting the regulated direct-current voltage to a high voltage alternating-current comprises a dc to ac inverter.

7. The assembles as specified in claim 6 wherein said dc to ac inverter comprises a JKL components SV power supply BXA-501 which inverts 5-volts dc to 700 Vrms.

8. The assembly as specified in claim 1 wherein said means for converting the high voltage alternating-current to a regulated direct-current high voltage comprise an eight-times multiplier and rectifier circuit.

9. The assembly as specified in claim 8 wherein the output of said eight times multiplier and rectifier circuit can be adjusted to provide an output from 1.25 KV to 5.6 KV.

10. A power supply assembly designed to produce a bias voltage that charges a diaphragm located on an electrolytic or electrostatic speaker driven by an audio amplifier, said assembly comprising:
a) a rectifier and filter circuit having means for receiving from the audio amplifier an input audio signal that is rectified and filtered to produce a direct current,
b) an adjustable regulator circuit having means for receiving the direct current and producing a regulated direct-current voltage that is set to an optimum level,
c) a dc to ac inverter circuit having means for receiving and converting the regulated direct-current voltage to a high voltage alternating-current,
d) an eight-times multiplier and rectifier circuit having means for receiving and converting the high voltage alternating-current to a regulated high voltage direct-current, and
e) a current limiter circuit having means for receiving and limiting the regulated high voltage direct-current prior to being applied as the output bias voltage to the diaphragm.

11. The assembly as specified in claim 10 wherein said rectifier and filter circuit means comprises a full-wave rectifier that rectifies the audio signal prior to being filtered by a pair of electrolytic capacitors to produce the direct current.

12. The assembly as specified in claim 11 wherein said adjustable regulator circuit means comprises an integrated circuit U1 connected to a pair of potentiometers R1 and R2, wherein the potentiometer R1 is externally adjustable to set the bias voltage at a preselected value, and potentiometer R2 is a trimmer adjustment that is factory set to limit the bias voltage to a maximum level.

13. The assembly as specified in claim 12 wherein the integrated circuit U1 is comprised of a National Semiconductor Inc. LM117T.

14. The assembly as specified in claim 13 wherein the bias voltage is set to a voltage between 3000 and 5000 volts d-c.

15. The assembly as specified in claim 10 wherein said dc to ac inverter circuit means comprises an integrated circuit U2 and capacitor C12 which function in combination to convert the regulated direct-current voltage to the high voltage alternating-current.

16. The assembly as specified in claim 15 wherein said integrated circuit U2 is comprised of a JKL Components Inc. BXA-501.

17. The assembly as specified in claim 10 wherein said eight-times multiplier and rectifier circuit means comprises a series of diodes D5-D12 and capacitors C5-C11 which function in combination to convert the high voltage alternating current to the regulated high voltage direct current.

18. The assembly as specified in claim 10 wherein said current limiter circuit means comprises a resistor ladder network from where the bias voltage is produced.

19. The assembly as specified in claim 18 wherein said resistor ladder network is comprised of current limiting resistors R4, R5, R6 and R7, wherein resistor R4 is connected to a reservoir capacitor C12 to ground and wherefrom resistor R7 the bias voltage is produced.
